(19) United States
(12) Patent Application Publication
(10) Pub. No.: US 2010/0281779 A1
(43) Pub. Date: Nov. 11, 2010

(54) Reversible sliding glass door

(76) Inventor: Mary Lou Vosburg, Las Vegas, NV (US)

Correspondence Address: Mary Lou Vosburg, 5170 Reiter Avenue, Las Vegas, NV, 89108, US

(21) Appl. No.: 12/387,739

(22) Filed: May 8, 2009

(51) Int. Cl. E05D 15/06

(52) U.S. Cl. 49/404

(57) ABSTRACT

This is a design for a sliding glass door that provides the option to choose an opening right to left, or change to an opening left to right at anytime. The outside panel of the door can slide to either end of the opening and lock into place. The inside panel, sliding can slide to either end of the opening.

### CROSS-REFERENCE TO RELATED APPLICATIONS

Not Applicable.

### STATEMENT REGARDING FEDERALLY SPONSORED RESEARCH OR DEVELOPMENT

Not Applicable.

### NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable.

### BACKGROUND OF THE INVENTION

This invention relates to the design for the manufacture of sliding glass doors that are used in building, including but not limited to private homes, apartments and commercial building.

Currently, sliding glass doors are manufactured with one half of the door fixed (the outside panel) and one half of the door (inside panel) sliding. There is a choice for a door that opens either right to left or left to right. The choice must be made prior to installation and once chosen, the door is installed to permanently open right to left or left to right. If the opposite opening is desired; the sliding glass door must replaced. This invention provides the design to allow the doorway opening right to left to change to a doorway opening left to right at anytime. This ability to change the access to a room will allow greater flexibility in furniture or equipment arrangements in the room.

### BRIEF SUMMARY OF THE INVENTION

The sliding door frame has three tracks, one for the outside panel and one for the inside (door) panel and one on the outside for a screen door. The outside panel can slide to either side of the opening and lock into place. The inside panel can slide from either end of the door frame to open and close for door access to the room or building. The screen door can slide to either end of the opening.

### BRIEF DESCRIPTION OF THE SEVERAL VIEWS OF THE DRAWINGS

FIG. 1: A cut out view for example of the three tracks that make up the top and bottom of the frame.

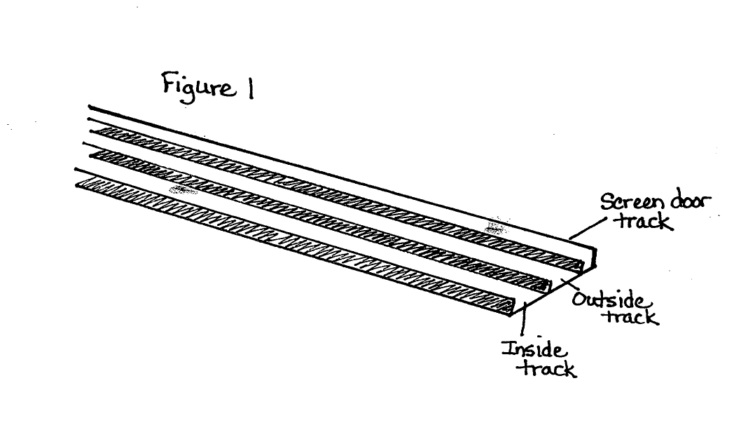

FIG. 2: An inside view of the outer panel. The locks shown on the top and bottom are deadbolt type locks. The bolt locks into the opening in the frame. And on the left side the lock hooks onto the frame of the doorway.

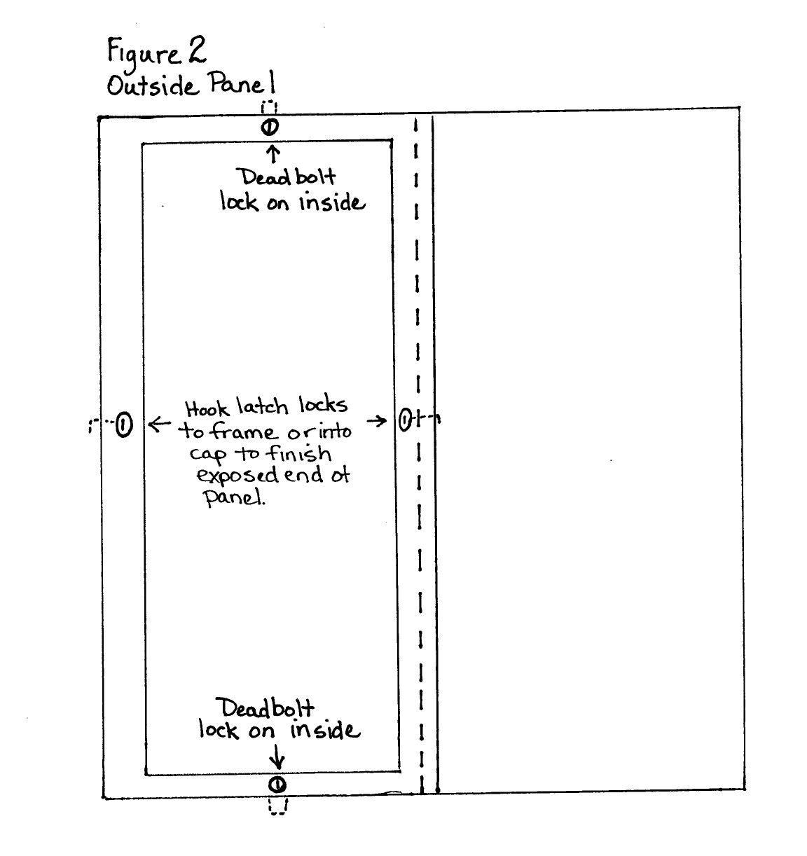

FIG. 3: The cap fits on the exposed end of the outside panel to provide a smooth finish. The outside panel has weather stripping on both ends to provide a seal when the panel is locked into place. The cap covers the weather stripping on the exposed end of the panel.

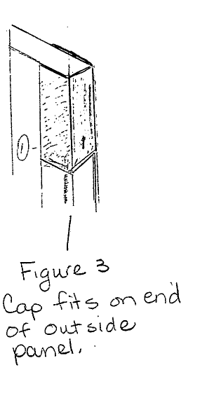

FIG. 4: The inside panel, sliding door has handles on both sides. In this example the door opens right to left. The handle on the right locks to the door frame to lock in the closed position.

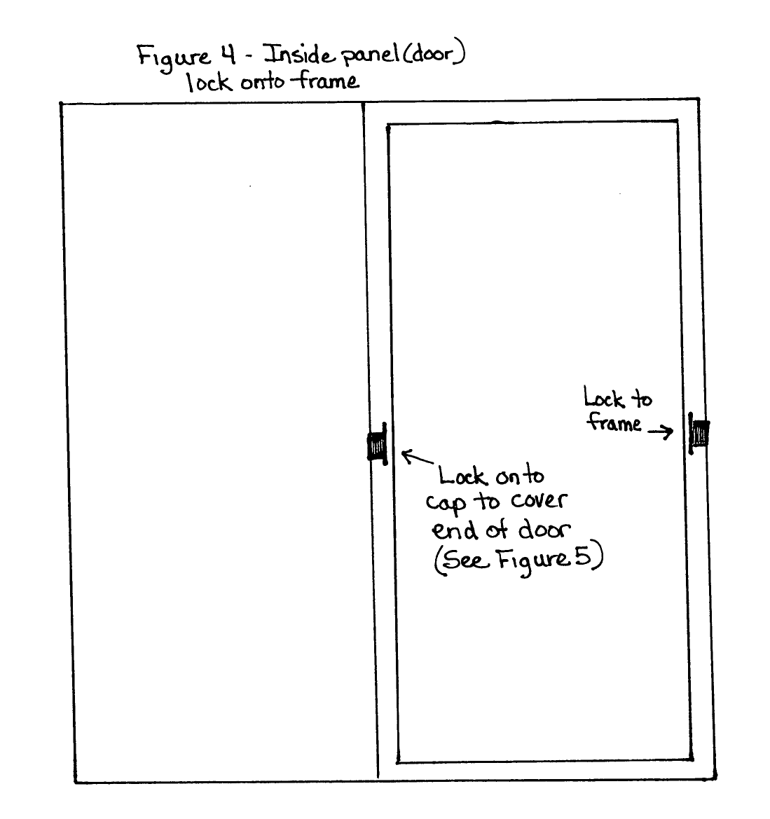

FIG. 5: The left handle locks to the cap that fits over the exposed end of the door.

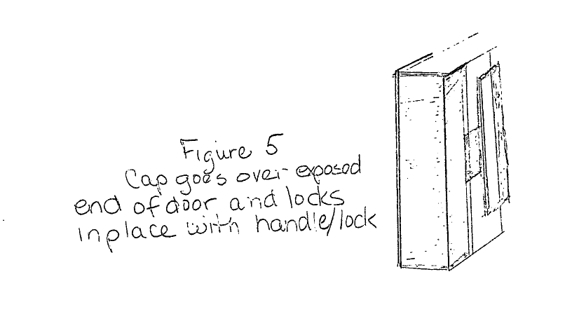

FIG. 6: This shows the insert that covers the open track for the outside panel. When inserted into the track, it provides a cover and smoother finish for the outside track. The cap for the end of the outside panel is attached after the insert is placed and when locked in place, locks the insert in place as well.

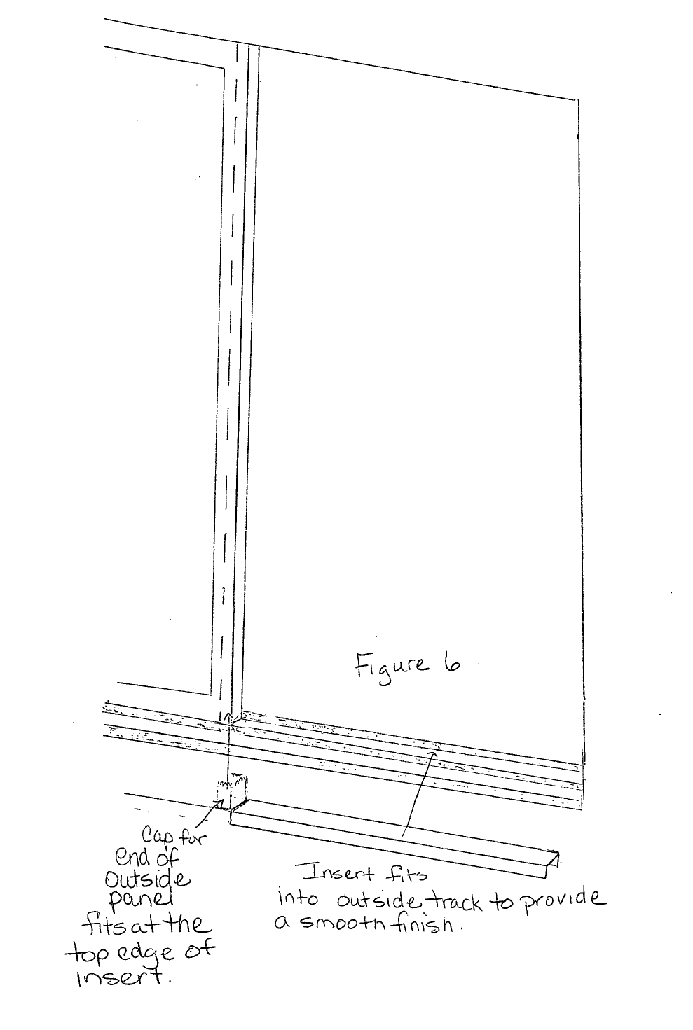

### DETAILED DESCRIPTION OF THE INVENTION

The sliding glass door is comprised of a frame with tracks that hold two panels, each cover half of the opening, there is an additional outside track for the sliding screen door.

The outer panel slides on the outside track and locks in place at either end of the opening to provide the security and support of the fixed portion of the sliding glass door assembly. The panel locks to the door frame on the top, bottom and side. The top and bottom locks can be either deadbolt type locks or clamp type locks as would be dictated by the construction material. For example, a deadbolt type lock would work better in a door manufactured in wood, a clamp type lock may work better in an aluminum door. The lock assembly is flush with the inside surface of the panel so as not to obstruct the sliding of the inside door panel. The lock on the side of the panel clamps or hooks to the frame to the secure the panel in position. The locks are the same on each side of the door frame.

Inserts cover the outside track to provide a finished, level surface for the open half of the door frame and also add to the security of the “fixed” portion of the sliding glass door. The insert consists of four (4) sections that may be separate pieces or connected. The sections insert into the top, side and bottom track openings (sections 1-3). The insert for sections 1-3 is U-shaped to fit inside and fill the track. Section 4 is a U-shaped cap that fits over the exposed end of the outer panel. On the inside of the U there is a latch that the locks with the lock on the side of the panel. When the cap is on the end of the panel, it overlaps the end of the insert for the top and bottom track inserts. The lock on the sides of the panel latch to the door frame on one side and lock to the insert on the other side, depending on the right or left opening that is chosen.

The inside panel, the sliding glass door, slides on the inside track. On the inside, the door has a handle and lock assembly on both sides. The handles on the outside of the door panel are indented for a flush surface on the outside of the panel to allow the door to slide past the outside panel. When the door opens right to left; the handle on the right, locks to the door frame to lock the door closed; and the handle on the left locks onto a cap for the end of the door panel. When the door opens left to right; the handle on the left, locks to the door frame to lock the door closed; and the handle on the right locks onto the cap for the end of the door panel.

The cap for the end of the panel is reversible to provide a finished edge to the exposed end of the door. The cap extends of the end of the door the same distance that the door closes into the door frame to close and seal. The weather strip that is on the inside of the door that seals it when closed into the door fame, also seals into the cap.

1. The current design of sliding glass doors require the decision of wanting the door to open right to left or left to right prior to the installation of the door. The direction of the door opening is permanent when the door is installed.
Where in the improvement comprises of what I claim in this design for a reversible sliding glass door. The outer panel is designed to move to either side of the opening and lock into place to maintain the security of a fixed outside panel. The design provides for a reversible sliding glass door.
As traditional sliding glass doors are manufactured in different materials, i.e. aluminum, plastic, wood; the type of locks that must be used to secure the outside panel and the door may vary. This does not affect the originality of the reversible sliding glass door.
There are different types of glass available for a sliding glass door, i.e. clear glass, stained glass, window pane designs, shades between the dual pane glass, etc. The different types of glass available do not affect the claim of originality for a reversible sliding glass door.
As traditional sliding glass doors are available in a variety of widths and/or heights, the width or height does not affect the claim of originality for a reversible sliding glass door. The measurements would only be changed to accommodate the desired opening.
